(19) United States
(12) Patent Application Publication
(10) Pub. No.: US 2009/0019667 A1
(43) Pub. Date: Jan. 22, 2009

(54) ADJUSTING DEVICE FOR FURNITURE PARTS

(76) Inventor: Horst Lautenschlager, Reinheim (DE)

Correspondence Address: WRB-IP LLP, 1217 KING STREET, ALEXANDRIA, VA, 22314, US

(21) Appl. No.: 11/574,000

(22) PCT Filed: Aug. 17, 2005
(86) PCT No.: PCT/EP2005/008902

§ 371 Date: Feb. 20, 2007

(30) Foreign Application Priority Data
Aug. 25, 2004 (DE) 10 2004 041 300.2

(51) Int. Cl. E05D 7/04; A47B 95/00; F16B 12/20

(52) U.S. Cl. 16/242

(57) ABSTRACT

An adjusting device for furniture parts includes an eccentric disk rotationally mounted on a first furniture part. The eccentric disk has, on its periphery, two eccentric surfaces which are axially offset from each other, extend in opposite directions with the same slope, and which interact with two opposite abutment surfaces that are axially offset from each other. Both abutment surfaces are formed on a housing that accommodates the eccentric disk and are joined to a second furniture part.

### BACKGROUND AND SUMMARY

The invention pertains to an adjusting device for furniture parts with at least one eccentric disk that is capable of rotation, which interacts with an abutment surface.

In the assembly of furniture parts, for example, when applying panels to drawers, or doors to the body of a piece of furniture, it is necessary, in many instances, to align the two parts to be joined, in relation to each other. Adjusting devices that render a lateral adjustment and/or adjustment of elevation possible serve this purpose.

Since an infinitely variable adjustment is desired in most instances, in adjusting devices of various structural types, screws or eccentric disks are frequently employed as adjustment elements that are capable of rotation. Eccentric disks have the advantage that they are flat so that the entire adjusting device can be embodied so as to be relatively flat.

In the case of customary adjusting devices that exhibit an eccentric disk that is capable of rotation as the adjustment element, an eccentric surface that constitutes the periphery of the eccentric disk interacts with an abutment surface. If the eccentric disk is rotated in one direction, it presses against the abutment surface, thus causing a relative positional shift between the two furniture parts to be joined. If, however, the eccentric disk is rotated in the opposite direction, contact with the abutment surface is maintained only if an external force is exerted upon the structural component that exhibits the abutment surface, in the direction of the eccentric disk. This may be the force of gravity, for example. If this does not suffice, an additional force must be exerted to keep the abutment surface engaged with the eccentric surface. The repositioning of the two furniture parts relative to each other in this latterly mentioned direction of positional shift, is thus relatively labor-intensive.

In addition, in every position, the danger exists that the abutment surface is lifted from the eccentric surface by a force that is brought to bear from the outside, so that the relative positional shift that is achieved by the adjusting process is unintentionally altered. To avoid this, it is necessary to secure both of the furniture parts, whose position relative to each other has been shifted in this position by the adjusting device by means of an additional measure, such as by clamping or screwing, for example. This additional [means of] securing must be released before any renewed adjustment can be undertaken.

It is desirable to embody an adjusting device of the type alluded to at the outset in such a manner that in any position, a connection that is form-fitting in either direction is assured between both furniture parts to be repositioned, so that an unintentional relative shift of the two furniture parts is reliably prevented, even without taking additional securing measures.

According to an aspect of the present invention, the eccentric disk, which is rotationally mounted on an initial furniture part, exhibits, on its periphery, two eccentric surfaces, running in opposite directions, that are axially offset against each other with the same slope, which interact with two abutment surfaces, lying opposite each other, that are axially offset against each other.

The eccentric disk, which is rotationally mounted on the initial furniture part, thus constitutes a double eccentric surface that exhibits two eccentric surfaces running in opposite directions, with the same slope, which, when viewed in the axial direction of the eccentric disk, are arranged next to each other. Each of these two eccentric surfaces interacts with an abutment surface that is allocated to it, such that these two abutment surfaces are, preferably, level and parallel, and lie opposite each other. In the case of a device that adjusts elevation, these two abutment surfaces are arranged above and beneath the eccentric disk; in the case of a lateral adjusting device, on either side of the eccentric disk.

When turning the eccentric disk in any arbitrary direction, both abutment surfaces remain engaged with the allocated eccentric surface in each case, because due to the identical slope and the opposite direction of slope of the two eccentric surfaces, the distance of the two points of contact from the abutment surfaces remains identical.

At the same time, the eccentric disk shifts relative to the abutment surfaces in the course of this rotation. Since the abutment surfaces are positioned securely on one furniture part, and the eccentric disk is rotationally mounted on the other furniture part, the position of both furniture parts is shifted relative to each other.

Since both eccentric surfaces, in both opposite directions, remain in constant contact with the allocated abutment surface in each case, a form closure continues to exist in either direction. Since the slope of such eccentric surfaces is customarily selected in such a manner that automatic locking is assured at the point of contact, in the case of this adjusting device, automatic locking is assured in both directions of adjustment. This means that the position selected as a result of the turning of the eccentric disk does not alter, not even if external forces are brought to bear upon the furniture parts that are connected to one another.

The two abutment surfaces are preferably embodied on a housing that accommodates the eccentric disk, said housing being connected to a second furniture part. Thus, the adjusting device can be applied to furniture parts in a simple manner, requiring little space.

The adjusting device can be employed to good advantage to connect two furniture parts that lie immediately atop each other. In lieu of that, the adjusting device can also be built into furniture fittings, for example, corner connection elements, or hinge brackets.

### BRIEF DESCRIPTION OF THE DRAWINGS

In what follows, the invention is explained in greater detail by virtue of embodiment examples that are presented in the drawings.

FIG. 1 shows an adjusting device for furniture parts in a horizontal projection;

FIG. 2 shows a section along the line II-II in FIG. 1.

FIGS. 3-8 show simplified representations to elucidate the manner in which the adjusting device works, such that FIGS. 3, 5, and 7 show the eccentric disk in a front view in each case, and FIGS. 4, 6, and 8 are sections along the lines IV-IV, VI-VI, and VIII-VIII;

FIG. 9 shows a derived embodiment of the adjusting device for the adjustable attachment of a panel on a drawer, in a vertical section;

FIG. 10 shows a view in the direction of the arrow X in FIG. 9;

FIG. 11, in a representation corresponding to FIG. 9, shows the parts in the assembled state;

FIG. 12 shows a derived embodiment of the adjusting device in the state prior to assembly, in a vertical section;

FIG. 13 shows the adjusting device according to FIG. 12 in the assembled state;

FIG. 14 shows the eccentric disk in a section and the tension lever according to FIGS. 12 and 13, prior to assembly;

FIG. 15 shows a view of the tension lever in the direction of arrow XV in FIG. 14;

FIG. 16 shows a common housing for an elevation adjusting device and a lateral position adjusting device, in a front view, such that the eccentric disks are omitted for the sake of simplified representation, and

FIG. 17 shows a section along the line XVII-XVII in FIG. 12.

### DETAILED DESCRIPTION

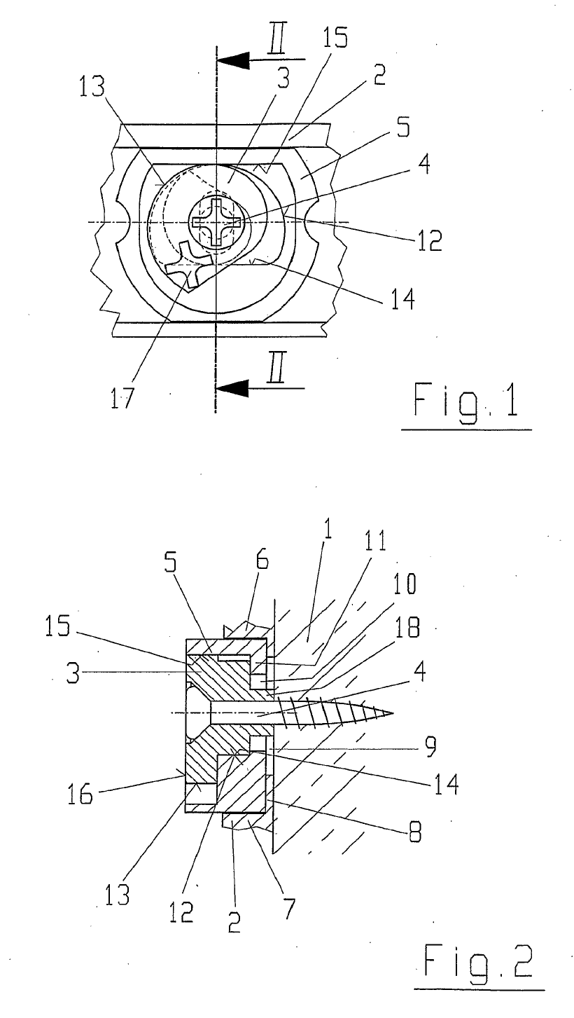

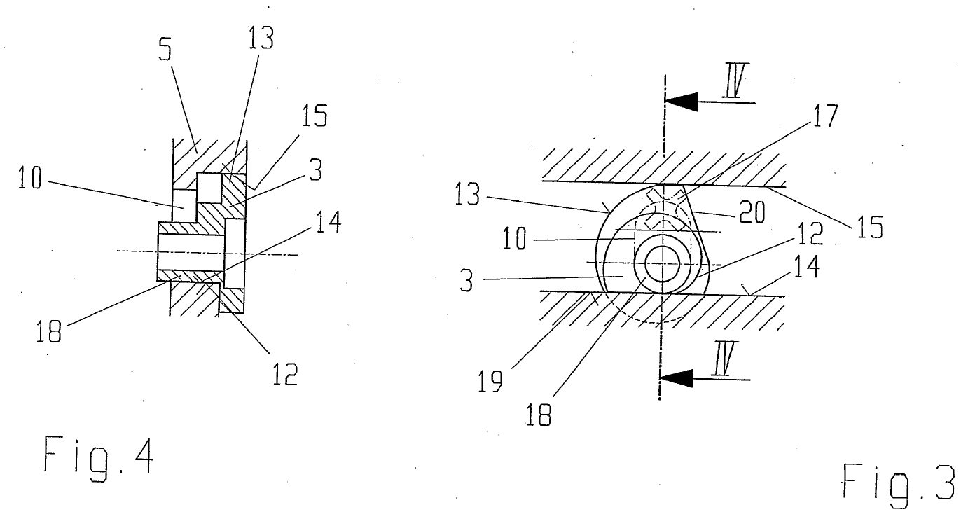

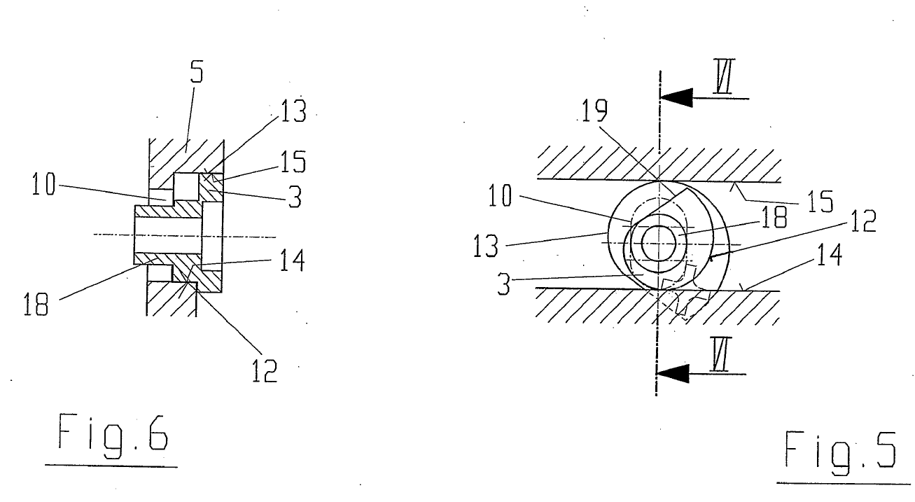

The adjusting device represented in FIGS. 1 and 2, which is elucidated in terms of its function in FIGS. 3-8, serves to effect a repositioning, in terms of elevation, of an initial furniture part 1, for example, a panel on a drawer, relative to a second furniture part 2, to which furniture part 1 is applied.

An eccentric disk 3, which is embodied as a double eccentric surface, is rotationally mounted on a screw 4 that has been screwed into the initial furniture part 1. The eccentric disk 3 is accommodated so as to be capable of rotation in a housing 5, which is connected to the second furniture part 2. For example, the second furniture part 2, with its angled edges 6, 7, encompasses housing 5. A web surface 8 of the second furniture part 2 exhibits a longitudinal hole 9, which extends vertically, through which screw 4 protrudes. A corresponding longitudinal hole 10 is left open in wall 11 of housing 5, which abuts web surface 8.

On its periphery, the eccentric disk 3 exhibits two eccentric surfaces, 12 and 13, axially offset against each other, which are embodied with the same slope, but increase in opposite directions, toward the periphery. The mean diameter of the inner eccentric surface 12 is smaller than the mean diameter of the outer eccentric surface 13.

The inner eccentric surface 12 lies beneath the axis of rotation of eccentric disk 3, against a lower abutment surface 14 embodied on housing 5. The external eccentric surface 13 abuts an axially offset upper abutment surface 15 of housing 5, opposite the inner abutment surface 14. Both abutment surfaces 14 and 15 are level and arranged parallel to each other. In the case of the embodiment example according to FIGS. 1 and 2, these abutment surfaces 14, 15, run horizontally. Both abutment surfaces 14, 15 are embodied on the housing 5 that accommodates the eccentric disk 3, which housing is connected to the second furniture part 2.

The eccentric disk 3, in its external face 16, exhibits an eccentrically arranged wrench or screwdriver projection 17, which, in the case of the embodiment example shown, is a Phillips projection for a Phillips screwdriver. The eccentric disk 3 can thus be turned by means of a screwdriver applied at the wrench projection 17.

The eccentric disk 3 is equipped with a central projection 18, which is led in the longitudinal hole 10, which extends in the direction of adjustment in the web wall 11 of the housing 5.

In the position schematically represented in FIGS. 3 and 4, projection 18 is found in its lowest position in the longitudinal hole 10. The lower abutment surface 14 touches the inner eccentric surface 12 at the point that is nearest its axis.

The upper abutment surface 15 touches the external surface of eccentric surface 13 at the point that is most remote from its axis. In this depiction of the terminal position, a flat surface 19 of the inner eccentric surface 12 abuts the lower abutment surface 14, thereby limiting the rotation of eccentric disk 3 in one direction of rotation.

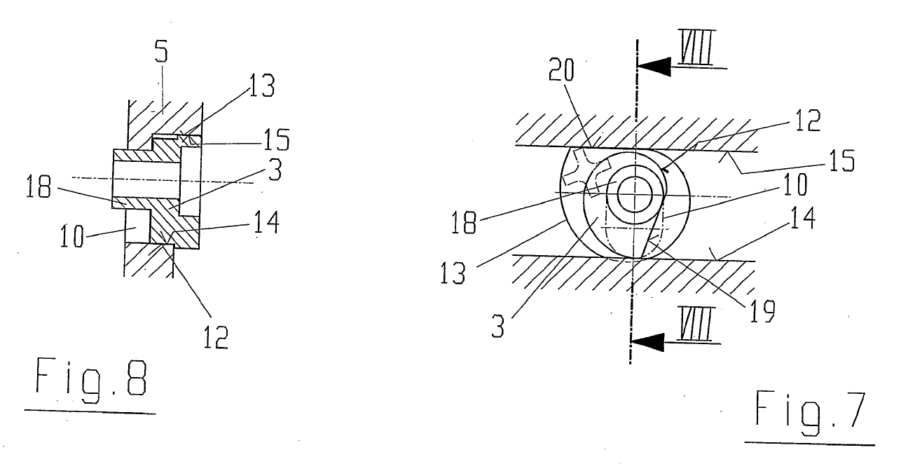

If the eccentric disk 3 is now turned clockwise in FIGS. 3 and 5, to the position shown in FIG. 5, the increasing eccentric surface 12 lifts the eccentric disk 3, and thus also the first furniture part 1, which is connected to it, relative to the abutment surface 14, the housing 5, and the second furniture part 2, making its way to the position shown in FIGS. 5 and 6. To the same extent, the external eccentric surface 13 withdraws, permitting the eccentric disk 3 to approach the upper abutment surface 15 to the same extent. The projection 18 of the eccentric disk 3 is located in the middle of the longitudinal hole 10.

If the eccentric disk 3 is brought to the terminal position depicted in FIGS. 7 and 8 as a result of having been turned further clockwise, a flat surface 20 of the external eccentric surface 13 comes to rest on abutment 14, so that the rotary movement is limited. The central projection 18 is found in it uppermost position in the longitudinal hole 10. The first furniture part 1 has reached its highest position relative to the second furniture part 2.

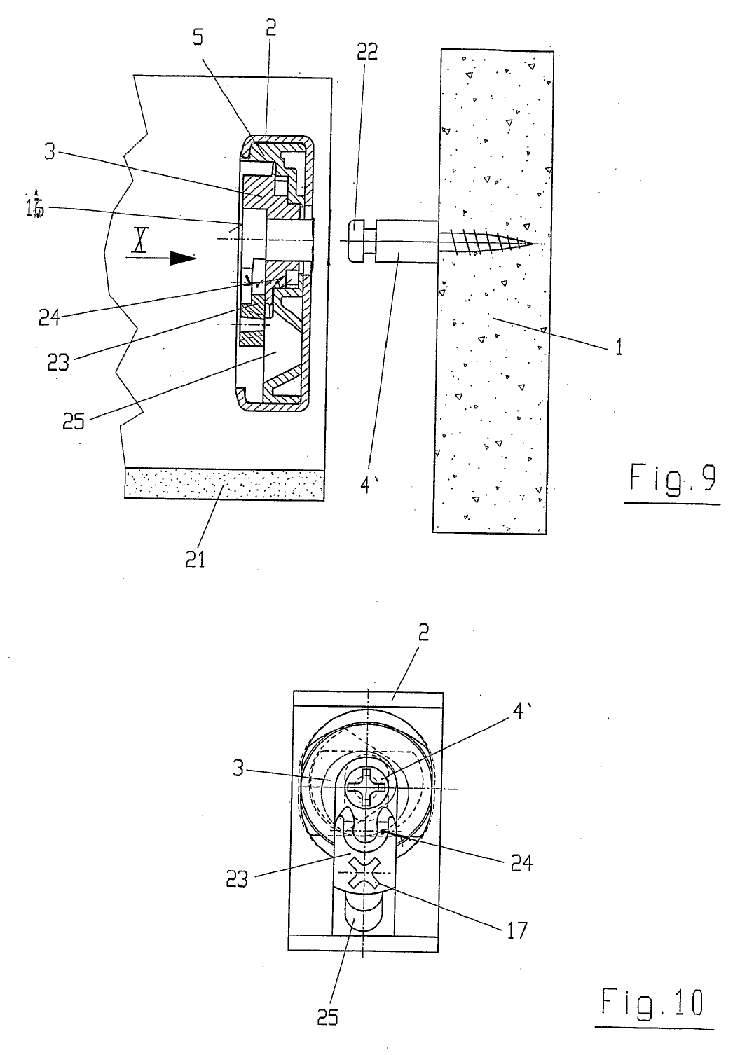

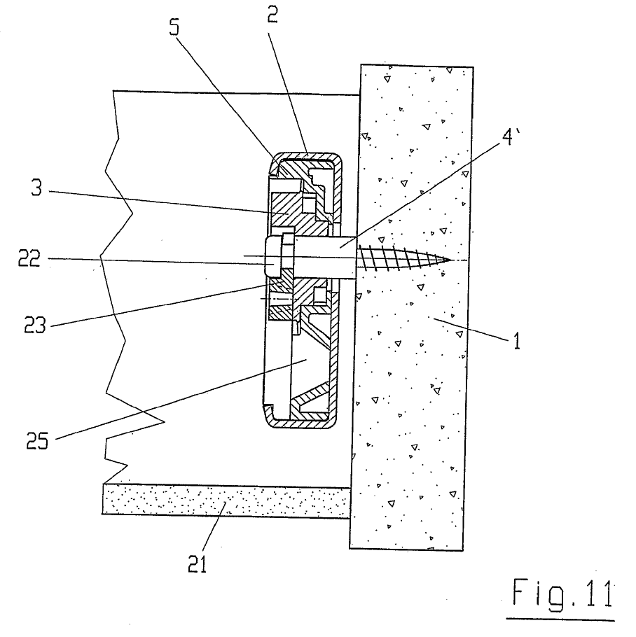

In the embodiment example represented in FIGS. 9-11, the elevation adjustment device serves simultaneously to secure a panel (furniture part 1) to an anterior transverse strip (furniture part 2) of a drawer 21. In this case, housing 5 of the adjusting device is accommodated in the transverse strip that constitutes furniture part 2. In the process, the possibility of a lateral shift may be provided for. In this case, the eccentric disk 3 is mounted on a screw 4,′ which exhibits a screw head 22 that projects radially, which screw exhibits a cylindrical journal for the purpose.

A locking slide 23 in the face 16 of the eccentric disk 3, whose position may be shifted radially, is approximately U-shaped in its basic outline, and it exhibits a locking stage 24 that can be inserted behind the screw head 22. By shifting the position of locking slide 23 radially (for example, by means of a screwdriver inserted into a depression 25 of housing 5 as a lever), the eccentric disk 3, and thus, the drawer 21, is fixed to the panel 1. Since the surface of the locking stage 24, which grips the screw head 22 from behind is embodied so as to increase in the radial direction after the manner of a wedge, tension is exerted in the process simultaneously on the screw 4′ in order to achieve a solid connection (bracing) of the furniture parts 1, 2.

The wrench projection 17, with which the eccentric disk 3 can be turned, is embodied, in this instance, on the locking slide 23.

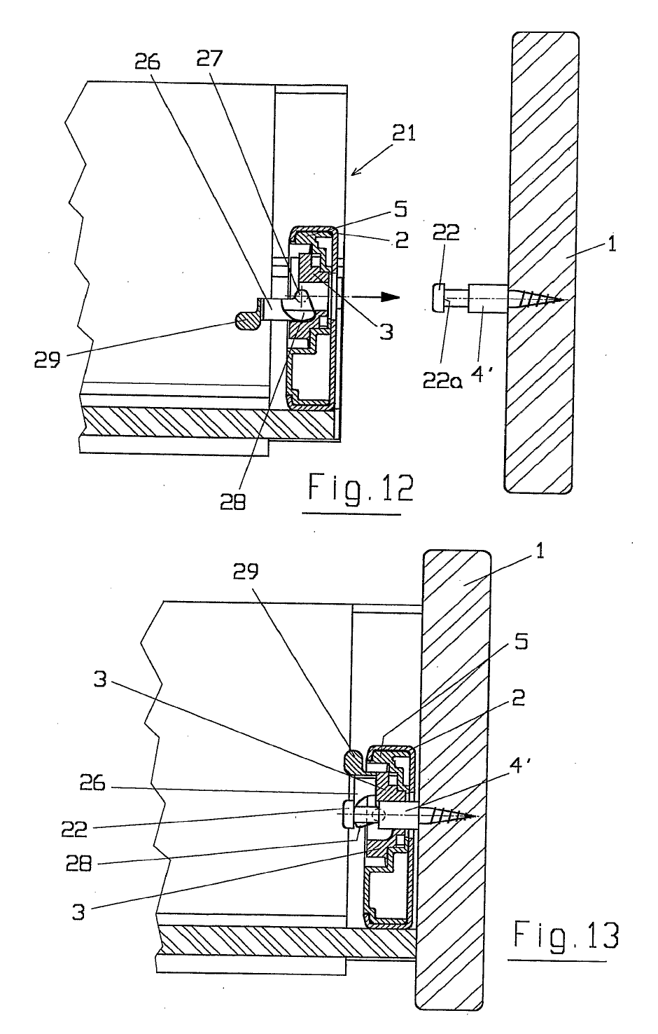

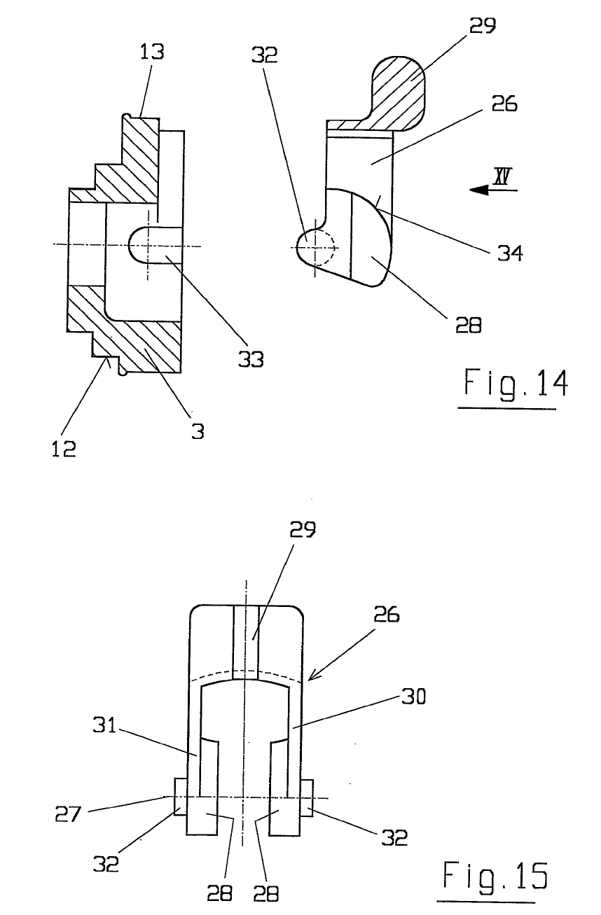

Another structural option for mounting the panel (furniture part 1) on the anterior transverse strip (furniture part 2) of drawer 21 is shown in FIGS. 12-15. This embodiment differs from the previously described embodiment, essentially, only by virtue of the fact that a tension lever 26, which can be rotated around a transverse axis 27 on the eccentric disk 3, is mounted on eccentric disk 3. The tension lever 26 exhibits at least one cam 28 (in the case of the embodiment example depicted, two cams 28), which, in the mounted state (FIG. 13) grips the screw head 22, which protrudes radially on the screw 4,′ from behind.

The tension lever 26 exhibits a grip segment 29, which, in the mounted state (FIG. 13), is arranged at a distance, radially from the axis of rotation of eccentric disk 3. The tension lever 26, is mounted, relative to this axis of rotation of eccentric disk 3 on the eccentric disk 3 so as to resist rotation.

As one recognizes from FIG. 15, the tension lever 26 exhibits two lever arms 30, 31, which, when installed, (FIGS. 12, 13), lie on either side of the screw 4′. Each lever arm 30, 31, exhibits an outwardly protruding bearing journal 32 at its free end in each case. Both bearing journals 32 are rotationally mounted in two bearing recesses 33 of the eccentric disk 3 that are open at the front.

At both free ends of the lever arms 30, 31, in addition, cam 28 is embodied, which protrudes inwardly toward screw 4′ and engages with the back side 22a of the screw head 22 with a cam surface 34, which increases relative to transverse axis 27.

To assemble the panel 1, the tension lever 26 is brought into the position depicted in FIG. 12, in which it stands tall from the eccentric disk 3 at the front. Then, the screw 4′ is introduced to the borehole of eccentric disk 3 and the tension lever 26 is moved around to the position shown in FIG. 13. In the process, both increasing cam surfaces 34 grip the screw head 22 from behind and as the tension lever is repositioned, they exert a tensive force on the back side 22a of the screw head 2.

In the position under tension (FIG. 13), the grip segment 29 lies at a distance, radially from the axis of rotation of eccentric disk 3. Since the tension lever 26, as a result of the engagement of its bearing journals 32 in the bearing recesses 33 of eccentric disk 3, is connected to the latter so as to be resist rotation relative to the eccentric disk's axis of rotation, the eccentric disk can be rotated to execute an adjustment of elevation or transverse position by means of the grip segment 29. No separate tool is required to do this.

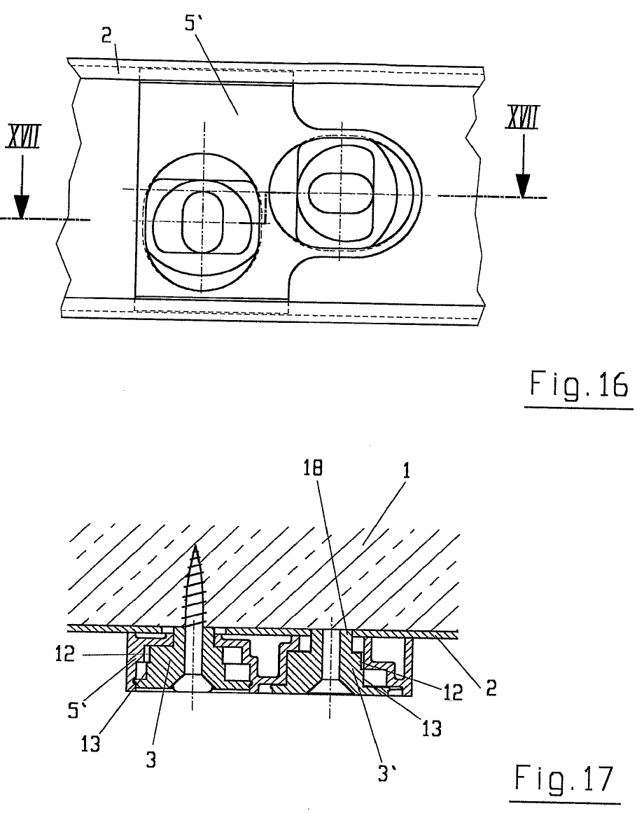

FIGS. 16 and 17 show that in a common housing 5′, two eccentric disks 3, 3′ (omitted in FIG. 16), each with two eccentric surfaces 12, 13, are mounted with adjusting directions that run at right angles to each other. The eccentric disk 3 serves to adjust the elevation, whereas the eccentric disk 3′ serves the purpose of lateral adjustment.

The housing 5′ is guided on the second furniture part 2, the anterior strip of a drawer, for example, in the direction of adjustment of the eccentric disk 3,′ which is rotationally mounted on the first furniture part 1, namely horizontally, so that its position can be shifted. Thus, by adjusting the two eccentric disks 3, 3,′ elevation adjustments and lateral adjustments can be undertaken independently of each other. In the process, the mounting of the eccentric disk 3′ on the second furniture part 2 occurs by means of the central bearing journal 18 of eccentric disk 3, which is rotationally mounted on furniture part 2 in a borehole.

1. An adjusting device for furniture parts, the adjusting device having at least one eccentric disk that is capable of rotation, the adjusting device being adapted to be rotationally mounted on a first furniture part, which also exhibits the adjusting device comprising, on its periphery, two eccentric surfaces with the same slope, the two eccentric surfaces being axially offset against each other, and running in opposite directions, the two eccentric surfaces being adapted to interact with two abutment surfaces of the adjusting device that lie opposite each other, and that are axially offset from one another, the eccentric disk being rotationally mounted on a screw that is adapted to be screwed into the first furniture part.

2. An adjusting device according to claim 1, wherein the two abutment surfaces are level and parallel.

3. An adjusting device according to claim 1, wherein the two abutment surfaces are on a housing of the adjusting device that accommodates the eccentric disk, the housing being connected to a second furniture part.

4. An adjusting device according to claim 3, wherein a central projection of the eccentric disk is disposed in a hole of a wall of the housing, the hole extending in a direction of adjustment.

5. An adjusting device according to claim 1, wherein the eccentric disk exhibits an eccentrically arranged wrench projection in its external front.

6. An adjusting device according to claim 1, wherein the screw exhibits a radially protruding screw head such that a locking slide with an arresting step may be inserted behind the screw head.

7. An adjusting device according to claim 6, wherein the arresting step is U-shaped.

8. An adjusting device according to claim 6, wherein the eccentric disk exhibits an eccentrically arranged wrench projection in its external front face and the wrench projection is on the locking slide.

9. An adjusting device according to claim 6, wherein the arresting step is wedge shaped.

10. An adjusting device according to claim 1, wherein the screw comprises a radially protruding screw head and wherein a tension lever, mounted on the eccentric disk so as to be capable of rotating around a transverse axis, engages with at least one cam behind the screw head.

11. An adjusting device according to claim 10, wherein the tension lever comprises a grip segment, the grip element being arranged, in a mounted state, radially at a distance from the axis of rotation of the eccentric disk, and wherein the tension lever, relative to the axis of rotation of the eccentric disk, is mounted on the eccentric disk so as to resist rotation.

12. An adjusting device according to claim 10, wherein the tension lever comprises two lever arms lying on either side of the screw, and at ends of the lever arms, an outwardly protruding bearing journal, mounted on the eccentric disk, and a cam is provided, the cam protruding inwardly toward the screw, the cam, with an increasing cam surface, is engaged with a back side of the head of the screw.

13. An adjusting device according to claim 3, wherein two eccentric disks, each having two eccentric surfaces with adjustment directions that run at right angles to each other, are mounted in a common housing, the housing on the second furniture part being adapted to be shifted in a direction of adjustment of one eccentric disk, which is rotationally mounted on the first furniture piece, and the other eccentric disk is rotationally mounted on the second furniture part

14. An adjusting device for furniture parts having at least one eccentric disk, the at least one eccentric disk being rotationally mounted on an initial furniture part, the at least one eccentric disk having, on its periphery, axially offset against each other, two eccentric surfaces running in opposite directions and with the same slope, the two eccentric surfaces interacting with two abutment surfaces of the adjusting device that lie opposite one another and are axially offset against each other, eccentric disk being rotationally mounted with a central bearing journal on the furniture part.
